(19) United States
(12) Patent Application Publication
(10) Pub. No.: US 2012/0073859 A1
(43) Pub. Date: Mar. 29, 2012

(54) POLYMER CORE WIRE

(75) Inventors: Wai Yew Lo, Petaling Jaya (MY); Yit Meng Lee, Kuala Lumpur (MY); Lan Chu Tan, Seksyen (MY)

(73) Assignee: FREESCALE SEMICONDUCTOR, INC, Austin, TX (US)

(21) Appl. No.: 12/889,428

(22) Filed: Sep. 24, 2010

(51) Int. Cl. H01B 5/14; B05D 5/12; H01B 13/00; C25D 5/54

(52) U.S. Cl. 174/126.4; 205/159; 427/117; 427/118; 427/113; 427/120; 977/742

(57) ABSTRACT

A wire capable of conducting electrical current has a polymer core and a coating layer surrounding the core. The coating layer, which may be, for example, gold or copper, conducts electrical current and the core provides strength so that the wire is able to withstand bending and breakage. Among other things, the polymer core wire is useful for connecting an integrated circuit to a lead frame or substrate.

### BACKGROUND OF THE INVENTION

The present invention relates generally to wires that conduct electrical current, and more particularly, to polymer core wires that conduct electrical current.

Wires for conducting electrical current such as electrical signals, power and ground are well known. In the semiconductor industry, wires made of copper or gold typically are used to connect the bond pads on a semiconductor die to the lead fingers of a lead frame. These metals are expensive and thus, the cost of the wire adds considerable cost to the packaging process.

Further, as the size of semiconductors decreases yet processing capability increases, more inputs and outputs are needed for communication with the integrated circuit. Thus, bond pads are placed closer together (pitch) so thinner wires are needed. However, such thin wires must also have the strength to resist bending and breakage caused by external forces, such as when a mold compound flows over the wires during encapsulation. It is well known that the forces exerted on the wires by the mold compound can cause the wires to contact one another. This is known as wire sweep. The mold compound also can break brittle wires or weak bonds.

Thus, it would be advantageous to have a very thin yet strong wire. It would also be advantageous have a wire that is less expensive in terms of the amount of the metals like Copper or Gold required to form the wires.

### BRIEF DESCRIPTION OF THE DRAWINGS

The invention, together with objects and advantages thereof, may best be understood by reference to the following description of the presently preferred embodiments together with the accompanying drawings. In the drawings, like numerals are used for like elements throughout.

FIG. 1 is greatly enlarged perspective view with an end thereof in cross-section of a wire in accordance with a first embodiment of the present invention;

FIG. 2 is a greatly enlarged perspective view of a wire with an end thereof in cross-section in accordance with another embodiment of the present invention; and

FIG. 3 is a flow diagram illustrating the steps of forming a wire in accordance with an embodiment of the present invention.

Those of skill in the art will appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION OF THE INVENTION

The present invention is illustrated by way of example and is not limited by the accompanying figures, in which like references indicate similar elements.

In one embodiment, the present invention provides a wire for conducting an electrical current including a non-conductive core and a coating layer formed over the non-conductive core. The coating layer is formed of a material that conducts electrical current, such as Copper, Gold, Aluminum or solder. The non-conductive core comprises a material that may be elongate in form and covered with the coating layer. In preferred embodiments of the invention, the core comprises a polymer, a carbon nanotube, or hair.

In another embodiment, the present invention provides a method of making a wire including the steps of providing a length of non-conductive material and plating a conductive metal over the non-conductive material. In one embodiment, a pre-plating metal may be plated over the non-conductive material before performing the plating step. The pre-plating material preferably is Nickel or Palladium, while the conductive metal plating material is one of Gold, Copper, Aluminum or solder.

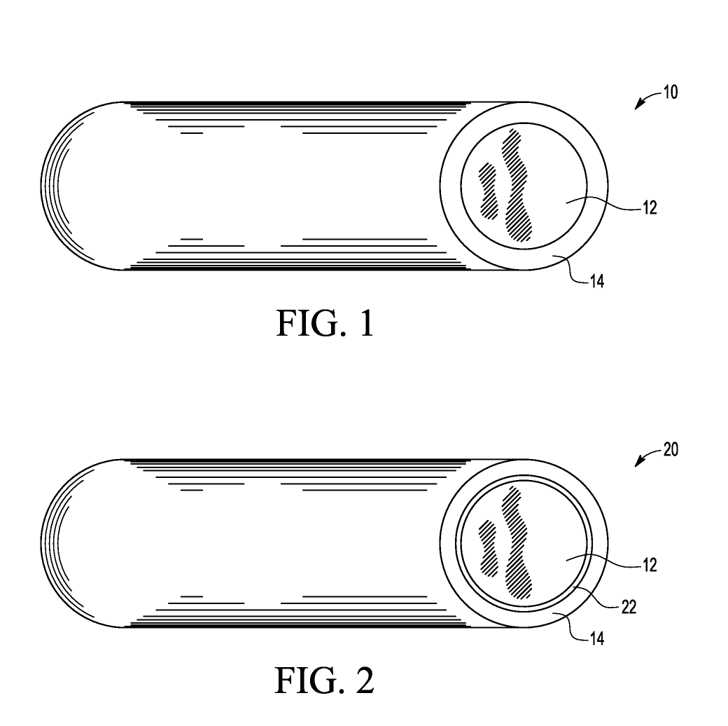

Referring now to FIG. 1, a wire 10 in accordance with an embodiment of the present invention is shown in perspective view with one end cut so that a cross-section of the wire 10 is visible. The wire 10 includes a non-conductive core 12 and a coating layer 14 formed over the non-conductive core 12. The nonconductive core 12 provides physical strength to the wire 10, while the coating layer 14 conducts electrical current.

The wire 10 is particularly suitable for conducting signals between an integrated circuit and external connection terminals therefor. For example, one end of the wire 10 may be bonded to a bonding pad of the integrated circuit and the other end of the wire 10 may be bonded to a lead finger of a lead frame or a bond pad of a substrate. For such uses, the wire 10 is connected to the integrated circuit bonding pad and the lead frame or substrate using commercially available wire bonding equipment. The heat or flame from the wire bonder melts the coating layer such that the coating layer will be bonded to either the IC bond pad, the lead finger or the substrate contact pad, as the case may be.

In accordance with an embodiment of the present invention, the non-conductive core 12 comprises a polymer, such as divinylbenzene cross-linked co-polymer or other nonconductive material. In another embodiment of the invention, the non-conductive core 12 comprises a strong yet flexible material such as carbon nanotubes, hair, or synthetic hair, which materials are thin yet strong enough to provide strength to the wire 10.

Carbon nanotubes are extremely thin, hollow cylinders made of carbon atoms. Carbon nanotubes can have a diameter on the order of a few nanometers, which is more than 10,000 times smaller than a human hair. However, they are extremely strong. The stiffness of a material is measured in terms of its Young's modulus, the rate of change of stress with applied strain. The Young's modulus of a nanotube can be as high as 1000 GPa which is approximately five times higher than steel. The tensile strength or breaking strain of nanotubes can be up to 63 GPa, around fifty times higher than steel. These properties, coupled with their lightness, make nanotubes a good choice for the non-conductive core 12. Furthermore, nanotubes may be constructed so that they are non-conductive. At present, carbon nanotubes have only been grown to a length of about 18 cm. However, with need (application and economic) and scientific development, this length is expected to increase over time so that nanotubes could replace the polymer material when it is economically feasible to grow the longer nanotubes.

As can be seen, the core 12 has a substantially uniform circular configuration. The particular diameter of the core 12 will vary depending on the material from which the core is constructed, but may have a diameter that ranges from between about 10 um and 250 um. The coating layer 14 has a thickness of about 10 um and if the core is metallized or pre-plated, the pre-plating metal has a thickness of about 1 um, giving the wire an overall diameter of between about 21 um and 261 um.

The coating layer 14 comprises a conductive material so that electrical signals (data, power, ground) may be transmitted to and from the bond pads of the integrated circuit to which the wires are connected. Metals currently used for conducting signals and that are applicable to the present invention include, but are not limited to, Gold, Copper, Aluminum and solder; and if solder, lead free solder is preferred. These metals can be plated over the non-conductive core 12.

Referring now to FIG. 2, another embodiment of a wire 20 in accordance with the present invention is shown. The wire 20 includes the non-conductive core 12 and the coating layer 14. However, prior to coating the core 12 with the conductive metal of the coating layer 14, the core 12 is pre-plated with a conductive metal 22. The pre-plating metal 22 is disposed between the non-conductive core 12 and the coating layer 14 and is provided to improve interfacial adhesion between the coating layer 14 and the core 12, and prevent electro-migration. The pre-plating metal 22 preferably is formed of a conductive metal such as Nickel or Palladium.

In a preferred embodiment of the invention, the wire 10 is a bond wire; which is a type of wire used to connect a bond pad of a semiconductor integrated circuit with a lead finger of a lead frame or a bond pad of a substrate (printed circuit board). Typically, such wires are used to transmit signals to and from the integrated circuit. Such signals may be data signals or power and ground. The voltage levels of such signals are relatively low, for example, between 0V and 5V. However, as is known in the art, the voltage level may be much lower as lower voltage integrated circuits now are being fabricated.

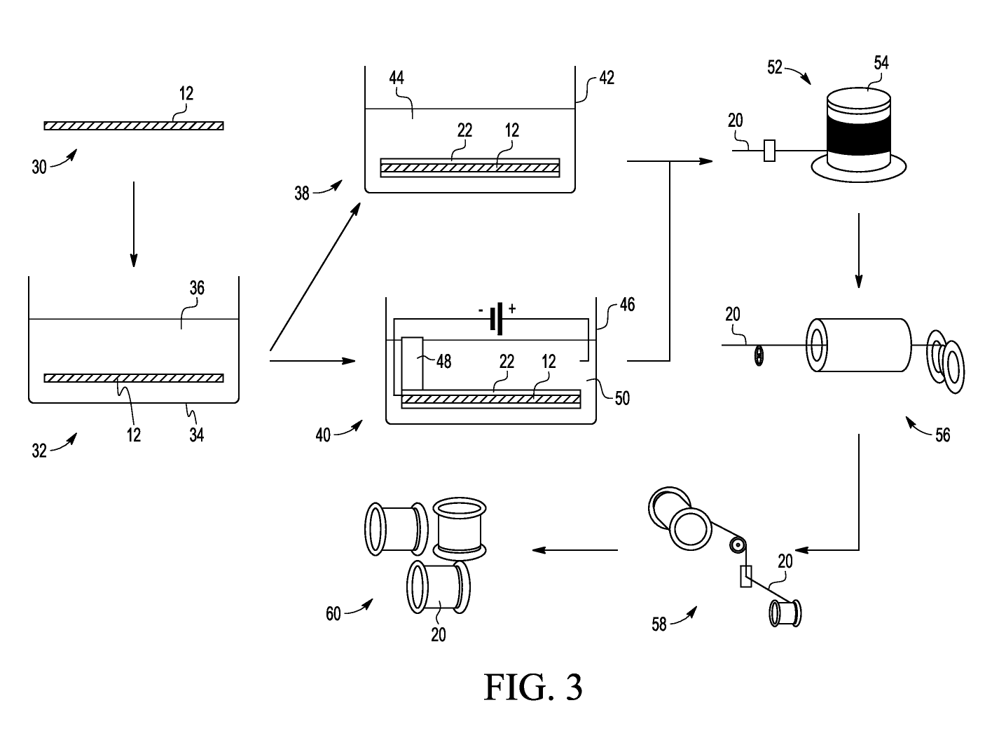

Referring now to FIG. 3, a process for making the wire 20 is illustrated. At a first step 30, a length of non-conductive material that forms the core 12 is provided. As previously discussed, the core 12 may comprise a polymer, hair, Carbon nanotubes, or the like. In one embodiment of the invention, at step 32, the core 12 is placed in a container 34 of aqueous solution 36 and metallized with a conductive metal via an electroless plating process. For example, the core 12 may be coated with a layer of Nickel or Palladium via an electroless pre-plating process. If the core 12 comprises Carbon nanotubes, then instead of electroless pre-plating, thin-film deposition may be used to coat the Carbon nanotubes with a thin layer of metal. The core 12 is coated with the pre-plating metal in order to allow for better adhesion of the conductive metal 14 applied to the core 12 in the next step.

Next, the conductive metal 14 is plated over the core 12 (or metallized core, as the case may be). The core 12 may be coated with the conductive metal 14 using either an electroless plating process illustrated at 38 or an electrolytic plating process illustrated at 40. In the electroless plating process, the metallized core 12 is placed in a second vat 42 of aqueous solution 44 and plated with the conductive metal 14, such as Copper. In the electrolytic plating process 40, a thin layer of metal is deposited on the core 12 (or metallized core). More particularly, the core 12 (or metallized core) is placed in a vat 46 filled with electrolytic solution 50 (e.g., copper sulfate) and the metal to be plated 14, in this example Copper, is used as an anode. In other embodiments, the metallized core is plated with another conductive metal such as Gold, Aluminum, or solder. The now plated, metallized core comprises the wire 20.

After the core 12 is plated with the conductive metal 14, at step 52 the wire 20 is wound around a spool 54. At step 56, an annealing process is performed in which the wire 20 is heated and then cooled in order to enhance the strength and hardness of the wire 20. As is known by those of skill in the art, if the coating layer 14 comprises Copper, then the cooling may be done slowly in air or quickly by quenching the wire 20 in liquid.

At step 58 the annealed wire 20 is rewound around a spool and then at step 60 the spools of the wire 20 may be inspected for defects. At this point, the wire 20 is ready for use with a commercially available wire bonding machine.

The process steps described above are generally well known steps and thus have not been described in any more detail than deemed necessary to depart to one of skill in the art a suitable method for manufacturing the wire 10. Thus, while embodiments of the invention have been described and illustrated, it will be understood by those skilled in the technology concerned that many variations or modifications in details of design or construction may be made that are still within the scope of the present invention. Also, because the tools for implementing the present invention are, for the most part, well known, as are the circuits, package structure, and compositions used to manufacture devices according to the present invention, details are not be explained in any greater extent than that considered necessary to describe the invention, for the understanding and appreciation of the underlying concepts of the present invention and in order not to obfuscate or distract from the teachings of the present invention.

In the foregoing specification, the invention has been described with reference to specific embodiments. However, one of ordinary skill in the art will appreciate that various modifications and changes can be made without departing from the scope of the present invention as set forth in the claims below. For example, although the present invention is particularly well suited as a bond wire, it will be understood by those of skill in the art that the principles discussed herein may be appled to larger diameter wires for carrying larger currents. Accordingly, the specification and figures are to be regarded in an illustrative rather than restrictive sense, and all such modifications are intended to be included within the scope of the present invention.

Further, relative terms such as “front”, “back”, “top”, “bottom”, “over”, “under” and the like in the description and claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. The terms “a” or “an”, as used herein, are defined as one or more than one. The term “plurality”, as used herein, is defined as two or more than two. The term another, as used herein, is defined as at least a second or more.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

1. A wire for conducting an electrical current, comprising:
a non-conductive core; and
a coating layer formed over the non-conductive core, wherein the coating layer conducts electrical current.

2. The wire of claim 1, wherein the non-conductive core comprises a polymer.

3. The wire of claim 2, wherein the polymer comprises divinylbenzene.

4. The wire of claim 1, wherein the non-conductive core comprises hair.

5. The wire of claim 1, wherein the non-conductive core comprises carbon nanotubes.

6. The wire of claim 1, wherein the coating layer comprises a conductive metal plated over the non-conductive core.

7. The wire of claim 6, wherein the conductive metal comprises one of Gold, Copper, Aluminum and solder.

8. The wire of claim 6, wherein the non-conductive core is pre-plated with a conductive metal, wherein the pre-plating metal is disposed between the non-conductive core and the coating layer.

9. The wire of claim 8, wherein the pre-plating metal comprises Nickel or Palladium.

10. A wire for conducting an electrical current, comprising:
a non-conductive core;
a first metal layer pre-plated over the core; and
a second metal layer plated over the pre-plated layer, wherein the first and second metal layers conduct electrical current.

11. The wire of claim 10, wherein the wire has an overall thickness of between about 30 um and 275 um.

12. A method of making a wire capable of conducting an electrical current, the method comprising the steps of:
providing a length of non-conductive material; and
plating a first conductive metal over the non-conductive material.

13. The method of making a wire of claim 12, further comprising the step of pre-plating the non-conductive material with a second conductive metal before performing the plating step.

14. The method of making a wire of claim 13, wherein the second conductive metal comprises one of Nickel and Palladium.

15. The method of making a wire of claim 14, wherein the first conductive metal comprises one of Gold, Copper, Aluminum and solder.

16. The method of making a wire of claim 12, wherein the non-conductive material comprises a polymer.

17. The method of making a wire of claim 12, wherein the non-conductive material comprises hair.

18. The method of making a wire of claim 12, wherein the non-conductive material comprises carbon nanotubes.

19. The method of making a wire of claim 12, wherein the plating step comprises one of electroless and electrolytic plating of Copper over the non-conductive core material.

20. The method of making a wire of claim 12, further comprising the steps of:
winding the plated, non-conductive material around a spool; and
unwinding and annealing the plated non-conductive material.
